(19) United States
(12) Patent Application Publication
(10) Pub. No.: US 2002/0110131 A1
(43) Pub. Date: Aug. 15, 2002

(54) System and method for arbitrating access to fibre channel system for storage or LAN interface applications

(76) Inventor: Stephen J. Elliott, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 09/782,993

(22) Filed: Feb. 12, 2001

(51) Int. Cl. H04L 12/56

(52) U.S. Cl. 370/405; 370/420; 370/412

(57) ABSTRACT

The present invention is related to the provision of a simplified interface to a Fibre Channel fabric. The present invention provides connection to a Fibre Channel fabric via a RS-232 interface. The present invention receives and buffers information received from the high bandwidth Fibre Channel system until communication via the RS-232 interface is possible. Likewise, the present invention receives and buffers information received from the RS-232 interface. The present invention waits until a predetermined amount of information is received before attempting to arbitrate access to the Fibre Channel system in order to minimize its effect of the Fibre Channel system. Moreover, the present invention utilizes the preceding mechanisms to emulate a Fibre Channel disk array for diagnostic purposes. Also, the present invention may be utilized by a number of PCs to provide an inexpensive LAN application.

### TECHNICAL FIELD

The present invention is related in general to fiber channel devices, and in specific to a simplified interface to a fibre channel fabric for storage applications or for inexpensive LAN applications.

### BACKGROUND

In recent years, high performance data processing systems have experienced significantly improved performance. Processing speeds continue to increase by extraordinary amounts. Application performance now depends upon inter-process and inter-processor communication rates. Older communication schemes were unable to provide communication rates acceptable for high-end multi-processor applications such as multimedia and scientific tasks.

To address these concerns, various industry participants have begun development of a set of standards, collectively known as Fibre Channel (FC), to provide a practical, inexpensive, scalable means of quickly transferring data between workstations, mainframes, supercomputers, desktop computers, storage devices, and other peripherals. First, FC utilizes a high bandwidth physical medium. FC utilizes interchangeably either a fiber optical cable or a twin-axial copper cable as a physical medium. In the subsequent text, the term “fiber” shall interchangeable refer to either a fiber optical cable or a copper cable. Secondly, FC utilizes a topology that is simplified in comparison to typical networking topologies. Exemplary architectures include point-to-point, arbitrated loop, and crosspoint switched topologies. In an FC system, communication occurs via serial links, i.e. an in-coming fiber for a device is also an out-going fiber for another device (either an independent component or a crosspoint fabric switch). FC provides the capability of communicating at very high communication rates, including rates within the gigabit range.

As typical with communication systems, FC comprises a number of hierarchical protocol layers. First, the FC-0 layer defines the physical link, including the fiber, connectors, optical parameters, electrical parameters, and the like. FC-1 layer defines the transmission protocol including serial encoding and decoding rules. FC-2 layer defines the transport protocols. FC-2 layer defines framing rules. Also, FC-2 layer provides three service classes for data transport. Specifically, FC-2 layer provides various methods of allocating bandwidth on the fiber connections over an FC topology. FC-2 layer provides class 1 service which allocates a dedicated portion of the bandwidth between two ports. FC-2 layer also includes classes 2 and 3 which utilize connectionless service, thereby allowing the bandwidth of the FC topology to be shared among the various ports. The only difference between class 2 and 3 is that class 2 provides acknowledgment frames. FC-2 layer further provides flow-control to prevent a data source from over-running a destination with data frames.

However, FC systems provide certain difficulties. First, malfunctioning components disposed in FC systems may be difficult to diagnose. Alternatively, diagnosis of such devices may require significantly expensive equipment. Additionally, known devices utilized to connect PC's to an FC system are quite expensive and complex. These characteristics are caused by the assumptions that underlie an FC system. Specifically, FC systems assume that devices present on the systems require high data communication rates. Thus, the present design of FC interface cards provide for high bandwidth capabilities which inherently increases complexity and expense.

### SUMMARY OF THE INVENTION

Accordingly, the present invention preferably provides an inexpensive and low complexity interface to FC systems. The present invention preferably translates data communicated via a low bandwidth protocol into the FC protocol and vice versa. The present invention may be utilized to provide an inexpensive mechanism to support LAN applications or as a diagnostic tool for FC related devices, such as Fibre Channel disk array systems. Additionally, the present invention may facilitate remote back-up or mirroring of storage media disposed upon an FC system.

The present invention may preferably provide a simple mechanism to FC arbitrated loop expansion. An arbitrated loop is a group of devices that are interconnected via the same communication media. Since the devices utilize the same communication media, it is necessary to define a communication protocol to allow devices to access the communication media in an orderly manner. Specifically, only one device may communicate over the media at any one time. Therefore, arbitrating involves following the defined communication protocol in order to ensure that a particular device is permitted to communicate before utilizing the communication media.

The present invention is directed to a system and method that provides a simplified interface to FC systems. The present system provides a well-known lower bandwidth interface to interconnect with an FC system. Specifically, the present invention preferably utilizes an RS-232 interface to receive data from an information source, although other low bandwidth interfaces may be utilized. The present invention formats the received data from a connected device for transmission over a fiber connection of the FC system. Moreover, the present invention receives and formats data from the FC fiber connection for communication to the connected device. In addition, the present invention preferably comprises configured buffers to provide for data rate translation from the slower RS-232 data protocol to the high bandwidth FC protocols.

The present invention may be utilized to provide any number of useful applications. In brief, the present invention may facilitate inexpensive and efficient LAN applications. Additionally and/or alternatively, the present invention may be employed in connection with diagnostic equipment to test devices placed upon an FC network. The hardware implemented in accordance with the present invention may be disposed in an FC network to allow diagnostic equipment to plug-in via an RS-232 port to perform necessary maintenance tasks.

In addition, the present invention preferably involves the use of an expansion slot. The expansion slot may preferably be designed to accept a second FC interconnection pair. By allowing the addition of a second FC interconnection pair, the present invention may allow simplified expansion of FC arbitrated loops.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1A illustrates an exemplary block diagram implementing the present invention.

FIG. 1B illustrates an exemplary expansion board to be utilized with an adapter implemented in accordance with the present invention.

FIG. 2 illustrates an exemplary system configuration utilizing the present invention allow a PC access to a disk array.

FIG. 3A illustrates an exemplary LAN system implemented utilizing the present invention and Fibre Channel interconnections.

FIG. 3B illustrates an exemplary remote data services system implemented utilizing the present invention and Fibre Channel interconnections.

FIG. 4 illustrates exemplary expansion of Fibre Channel arbitrated loop topologies utilizing the present invention.

### DETAILED DESCRIPTION

Turning now to the Drawing, FIG. 1A illustrates an exemplary block diagram implementing the present invention. FIG. 1A comprises adapter 100. Adapter 100 includes two FC ports that provide the FC-0 physical layer. The ports include FC-IN 101A and FC-OUT 101B. It shall be appreciated that adapter 100 comprises various other components that are not shown. For example, adapter 101 may comprise the relevant laser diode and optical detector components necessary to implement the fiber optical physical layer. Adapter 101 may alternatively comprises relevant electromagnetic transmitter and receiver components. However, the present discussion will focus upon the operation of the components implementing the present invention. Standard components related to the FC system or the RS-232 interface will only be discussed to the extent necessary to describe the present invention.

Adapter 100 further comprises RS-232 interface 102. It shall be appreciated that adapter 100 may be designed to utilize other low bandwidth interfaces. However, the present invention utilizes RS-232 interface 102, since it is a well-known standard. Accordingly, a large number of software and other applications may operate with the present invention with very little modification.

Adapter 100 includes microprocessor 103. Adapter 100 further includes buffer (RAM) 104. Depending upon specific requirements, buffer 104 may comprise DRAM components, SRAM components, or a combination of the two. As will be discussed in greater detail below, buffer 104 may preferably be extensively utilized to perform protocol translation between the high bandwidth FC protocol and the lower bandwidth RS-232 protocol. Moreover, adapter 100 may preferably comprise non-volatile memory 105. Nonvolatile memory 105 may be implemented in any number of forms, such as EEPROM or flash memory. It shall be appreciated that adapter 100 may be preferably be configurable to perform specialized tasks via additional executable instructions as will be discussed in greater detail below. Specifically, such additional application specific instructions may be stored in non-volatile memory 105.

Adapter 100 is preferably designed to be placed into an FC system. Adapter 100 receives the high bandwidth FC signal from FC-IN 101A. Since the adapter serves as an active a port on the FC system, the microprocessor processes the received signal to determine if any of the received information is intended for it. In this case, it has been assumed that the FC system is an arbitrated-loop topology. However, the present invention may be practiced with other topologies. The microprocessor places this information in a predefined portion of buffer 104. Since adapter 100 is designed to interface to a lower bandwidth protocol based communication channel, it is contemplated that a very small minority of the FC channel traffic will be intended for adapter 100. Accordingly, the vast majority of information received is simply forwarded to the next device on the FC system via FC-OUT 101B. Microprocessor 103 may utilize buffer 104 for transient storage of information before forwarding the information to the next device. The forwarding functionality of adapter 100 is performed in accordance with the Fibre Channel standards, the details of which are beyond the scope of the present discussion. The requisite functionality of a Fibre Channel device may be obtained from the American National Standards Institute (ANSI) Fibre Channel standards.

Microprocessor 103 is preferably a high-speed microprocessor. Accordingly, microprocessor 103 is capable of performing other tasks in additional to forwarding information between FC-IN 101A and FC-OUT 101B. According to interrupt scheduling, microprocessor 103 may locate previously buffered information received from FC-IN 101A intended for the adapter. Microprocessor 103 preferably processes the information in accordance with higher level FC protocols such as decoding operations to produce raw data. Thereafter, microprocessor 103 processes and communicates the data for communication RS-232 interface 102. In a similar fashion, information is received from RS-232 interface and processed according to RS-232 protocols. The resultant information is placed into buffer 104. Microprocessor 103 further processes the information into a form appropriate for transmission in accordance with FC protocols. Depending upon the FC topology, microprocessor 103 arbitrates to gain bandwidth access to the FC system. Upon gaining the requisite access, the information is communicated via FC-OUT 101B.

Microprocessor 103 may perform the preceding and additional functionality in accordance with an instruction set. The instruction set is preferably stored in non-volatile memory 105. Upon initialization, the instruction set stored in non-volatile memory 105 may be copied into an active portion of memory for execution. Furthermore, adapter 100 preferably allows the instruction set to be updated. Adapter 100 may allow the updates to the instruction set to occur via the FC system or via the RS-232 interface.

It shall be appreciated that the FC system interfaces and the RS-232 interface perform data communication at vastly different rates. FC systems permit gigabit communication over the physical medium. In contrast, communication over RS-232 interfaces occurs at a much lower rate in comparison. Thus, the buffering functionality of adapter 100 is quite important with the present invention. First, information received from RS-232 interface 102 is received and stored until a significant amount of information is transferred. The aggregate collection of buffered information is preferably then transferred via a discrete set of FC transactions. Specifically, FC arbitrated loop topologies operate in a manner similar to token ring networks. A port (device) on an FC arbitrated loop arbitrates or gains a dedicated connection to a destination device. Accordingly, adapter 100 preferably waits until a predetermined amount of information has been buffered before attempting to obtain a dedicated connection. By doing so, the present invention minimizes the number of times that it arbitrates and thus minimizes its effect on the FC system.

Similarly, FC system buffers information received from FC-IN 101A. It is clearly evident if adapter 101 receives information intended for distribution via RS-232 interface, the RS-232 data rate cannot keep up with the FC physical layer data rate. Thus, adapter 100 receives the information related to a particular transfer directly. After completion of a set of frame transfers, the communication received via FC-IN 101A may cease. At this point, microprocessor 103 may preferably initiate communication via RS-232 interface. The buffered information may be drained from buffer 104 via the RS-232 interface to a connected device. After the information is transferred and the buffer is substantially emptied, adapter 100 is capable of receiving more information from the FC system for communication to the connected device. Also, it shall be appreciated that adapter 100 preferably prevents buffer 104 from being overwritten by utilizing the FC-2 layer data flow control signaling.

Adapter 100 preferably includes expansion slot 106. Expansion slot 106 preferably is designed to accept a second board for arbitrated loop expansion. As shown in FIG. 1B, expansion board 107 comprises a second set of fiber connections, FC-IN 108A and FC-OUT 108B. Moreover, adapter 100 is preferably designed such that the normal FC communication path begins by receiving information at FC-IN 101A. If the expansion board is not present, the FC communication exits through FC-OUT 101B. However, adapter 100 is preferably designed such that if the expansion board is present, the communication path continues via FC-OUT 108B. As will be discussed in greater detail below, FC-OUT 108B provides a FC connection to a FC loop. After the FC communication signal proceeds through the additional FC loop, the communication path is completed by receiving the FC signals via FC-IN 108A and transmitting the signals via FC-OUT 101B.

Adapter 100 may perform any number of applications that are not presently possible with FC systems. For example, adapter 100 may be utilized in connection with certain diagnostic tasks. For example, adapter 100 may be utilized to debug FC storage systems. In known FC applications, disk arrays are disposed at one end of an FC link. In addition, a UNIX platform may be disposed at another FC link which utilizes the FC connection to access the storage capacity of the disk array. However, this type of configuration has proved to be very difficult to debug. Specifically, it may be very difficult to ascertain whether a particular UNIX platform is compatible with a disk array controller. For example, fiber channel patch boards may be utilized to attempt to perform debugging tasks. Fiber channel patch boards merely allow access to the raw information transmitted over the fiber connection. The accessed data may be stored and subsequently analyzed to determine inconsistencies between actual and desired operations. However, fiber channel patch boards are not designed to emulate a specific device such as a disk array. Accordingly, a fiber channel board does not allow a user to run specific diagnostic routines and immediately determine any variant behavior.

However, the present invention allows real-time analysis of the compatibility between platforms and associated peripherals such as disk arrays. For example, the programable nature of the present inventive interface allows the interface to mimic or emulate a disk array. In a preferred embodiment, the interface may be configured to implement disk array protocol tasks, such as file creation, appending data to a file, reading data from a file, and/or the like. It shall be appreciated that the memory requirements of adapter 100 for disk array diagnostic purposes are not excessive. Specifically, compatibility may be equally well determined utilizing smaller files as compared to large files. For example, a disk array may store a database comprising gigabytes of information. However, it is unnecessary to utilize such a large data structure for diagnostic purposes. The operation of the UNIX device array may be effectively diagnosed by writing a 100K file to the diagnostic adapter. The diagnostic adapter emulates the operations of a disk array by implementing disk array protocols associated with communicating the file and storing the file. However, the file is stored in memory associated with the diagnostic adapter in lieu of actual disk media. Also, the stored file may then be analyzed for diagnostic purposes. The provision of such memory capacity in buffer 104 is quite acceptable and inexpensive. In addition, the inventive interface may be connected to a diagnostic personal computer (PC) via the RS-232 interface. The stored data may be communicated to the diagnostic PC. The diagnostic PC may display various data written to the various files and the data read from the various files. Since the data is originating at the peripheral device level, debugging is greatly simplified. The inventive interface may be programmed such that it only outputs data according to the disk array protocols. The adapter may preferably output the data before application of the Fibre Channel protocol, thereby simplifying the diagnostic process.

Thus, it is a further advantage of the present invention to analyze Fibre Channel device compatibilities. It shall be appreciated that the RS-232 interface is a standard serial interface. A large number of technical personnel are familiar with programming applications utilizing this standard interface. Accordingly, a network administrator is not required to have any knowledge of Fibre Channel protocols to determine the accuracy of software drivers, network interfaces, or other applications, that utilize the Fibre Channel structure as a transport mechanism. Instead, the network administrator may simply utilize the known operation of RS-232 serial interfaces to analyze the higher-level protocol signaling associated with various devices including Fibre Channel disk arrays.

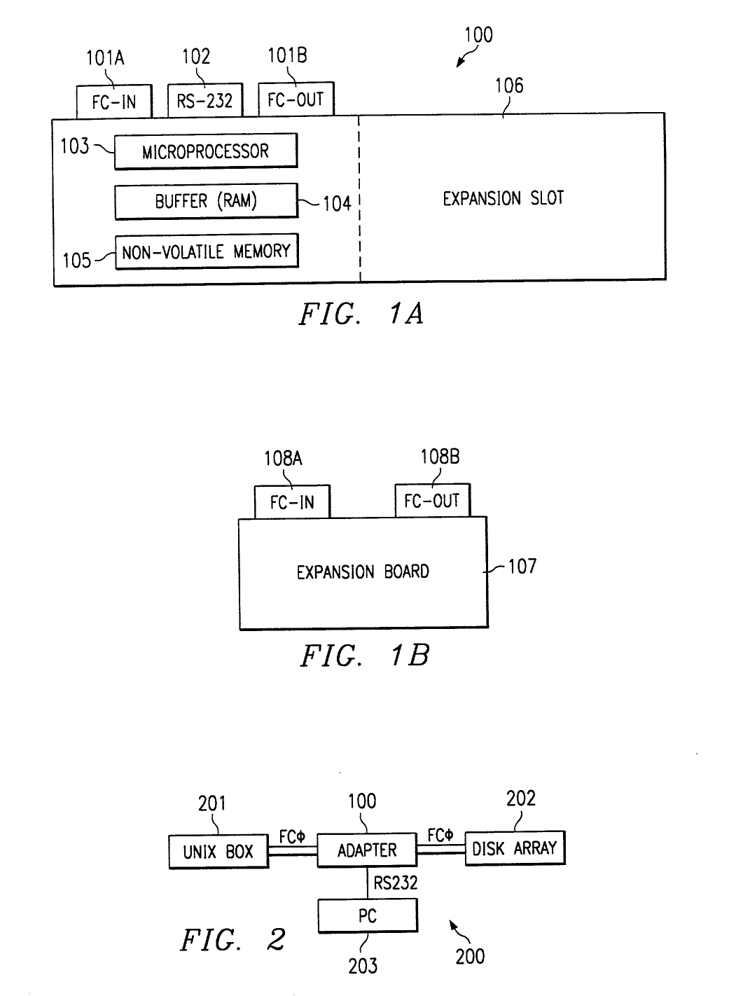

FIG. 2 illustrates an exemplary system 200 utilizing the present invention. System 200 comprises UNIX box 201 disposed in an arbitrated loop Fibre Channel system. System 200 further comprises disk array 202. System 200 also includes adapter 100 disposed in the arbitrated loop between UNIX box 201 and disk array 202. Adapter 100 is also connected to PC 203 via an RS-232 connection. In this configuration, adapter 100 may provide access to the disk array 202 for LAN purposes. Alternatively, adapter 100 may facilitate diagnostic tasks pertaining to the Fibre Channel system and disk array 202. The configuration of FIG. 2 is advantageous for several reasons. Most importantly, additional devices may communicate over the FC system without requiring disconnection and reconnection of any FC fibers. Adapter 100 may be disposed in the arbitrated loop at initial system configuration. Adapter 100 then permits plug-in connection of various diagnostic equipment or other equipment via the RS-232 port with minimal effort.

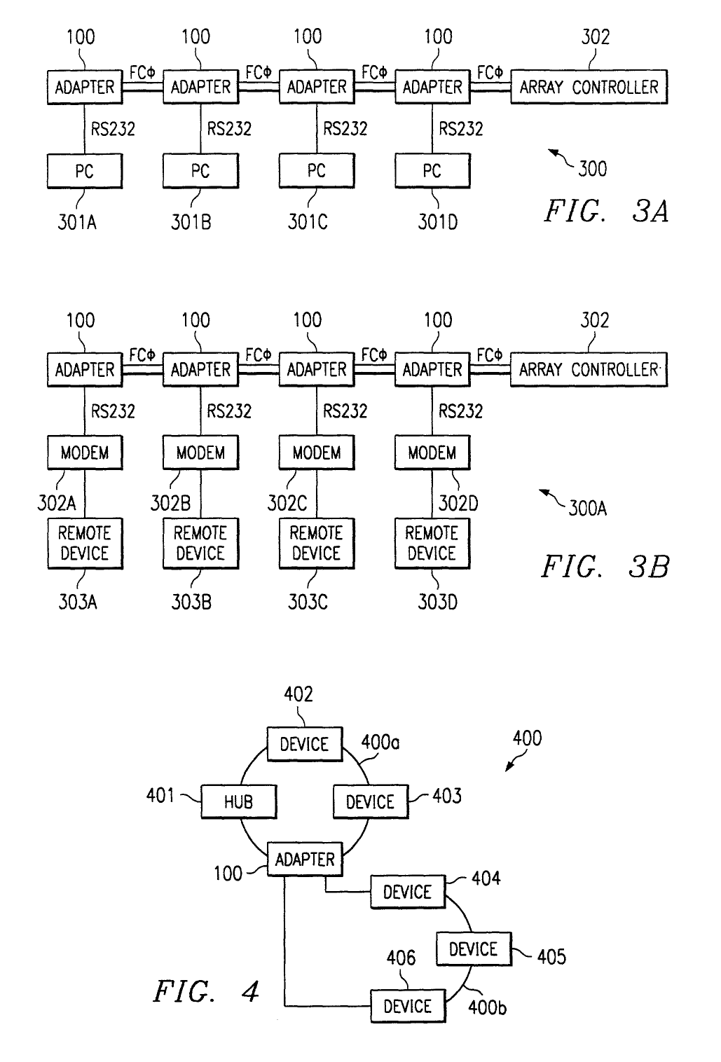

FIG. 3A illustrates another exemplary system utilizing the present invention. System 300 comprises a LAN network utilizing Fibre Channel connections. System 300 provides a local area network which includes PCs 301A-301D. PCs 301A-301D are connected to the LAN via a number of inventive adapters 100. The connections between the PCs and the adapters are made via RS-232 interfaces. However, the LAN interconnection occurs via high bandwidth Fibre Channel connections. Also, system 300 includes array controller 302. Array controller 302 may comprise storage media such as network drives for use by PCs. Additionally or alternatively, array controller 302 may provide higher level protocols. For example, array controller 302 may implement medium access procedures, security protocols, drive accessability schemes, and/or the like.

As shown, system 300 comprises a small number of PCs. However, it shall be appreciated that system 300 is shown in such a manner for simplicity only. The present invention contemplates that many more PCs may be connected to a LAN in a similar configuration. In fact, the bandwidth of the Fibre Channel physical layer is significantly greater than the bandwidth of the RS-232 connections. Accordingly, a large number of PCs may utilize the Fibre Channel backbone without exceeding the Fibre Channel bandwidth capability. Moreover, the connected devices need not necessarily be limited to PCs. Any device associated with a typical LAN may be connected in such a configuration. For example, other personal computers, printers, facsimile devices, scanners, and/or the like may be utilized in connected with the present LAN application. Thus, it is a further advantage of the present invention to provide a simple and efficient interconnection for LAN applications.

In an alternative embodiment, a similar system architecture may be utilized to provide remote data access services. Such an exemplary system is shown in FIG. 3B. System 300A possesses essentially the same system architecture as system 300. However, PCs 301A-301D have been replaced by modems 302A-302D. By utilizing modems 302A-302D, remote devices 303A-303D may gain access to the Fibre Channel connections to array controller 302. Remote devices 302A-303D may include any number of devices. For example, personal digital assistants (PDAs), Internet appliances, network terminals, application specific wireless phones, and/or the like may obtain remote access. Thus, this configuration may allow any number of devices to remotely obtain data associated with array controller 302. For example, array controller 302 may implement traditional corporate intranet data services. In an alternative embodiment, system 300A may provide an exemplary configuration for an Internet Service Provider (ISP). In this situation, array controller 302 may provide a connection to the Internet infrastructure. Each modem unit may provide the capacity of managing a dial-up connection. The data received by each modem unit may be assembled and/or multiplexed to array controller 302 via the Fibre Channel protocols. Additionally, array controller 302 may receive incoming data packets intended for a particular user. The data packets may be communicated to the appropriate modem unit and corresponding dial-up connection via the Fibre Channel links. The present invention may be utilized in connection with various remote mirroring applications. For example, a corporation may find it necessary to maintain two sets of identical enterprise-critical data in separate geographical locations. At the present time, modem devices do not operate directly on a Fibre Channel system. The present invention provides a simplified interface to facilitate a modem connection for remote mirroring. Specifically, a data storage device may be disposed in a Fibre Channel system. The present invention may allow a device to connect to the Fibre Channel system via the RS-232 interface. Moreover, a modem may be associated with the device. By utilizing this arrangement, data may be transmitted and received between a remote system and the Fibre Channel system via the modem. Moreover, the remote system may have access to the Fibre Channel system's storage device. Thereby, remote mirroring applications may utilize this arrangement to store identical sets of data on the remote system and on the Fibre Channel system.

FIG. 4 illustrates another arbitrated loop expansion utilizing the present invention. System 400 comprises a first loop topology 400a. System 400 comprises a second loop topology 400b. Hub 401, devices 402-403, and adapter 100 are disposed in topology 400a. Hubs are well-known devices common to fibre channel arbitrated loop topologies. Specifically, hub 401 links individual elements together to form a shared bandwidth loop and may perform various management tasks such as device supervision. Adapter 100 and devices 404-406 are disposed in topology 400b. Adapter 100 is designed to provide an interconnection such that topologies 400a and 400b appear as a single arbitrated loop. It is contemplated that topology 400a is a pre-existing arbitrated loop. Eventually, expansion may be required due to the necessity of adding additional devices. For example, new employees may be connected to the network via new PCs. As previously noted, adapter 100 preferably comprises expansion slot 106. Expansion board 107 comprises a second set of fiber connections, FC-IN 108A and FC-OUT 108B. Adapter 100 is preferably designed such that if the expansion board is present, the communication path continues via FC-OUT 108B. FC-OUT 108B may be connected to another Fibre Channel loop. The other end of the Fibre Channel loop may be terminated at FC-IN 108A and transferred back to the original loop via FC-OUT 101B. However, if the expansion board is not present or if there are no connected fibers on the expansion board, adapter 100 simply continues the Fibre Channel loop. By providing the additional ports and the switchable path, the present invention provides simplified expansion of arbitrated loops. Accordingly, instead of splicing the fiber of the original loop and disrupting communication, another loop may be added via adapter 100. Thus, it is an advantage of the present invention to facilitate plug-in expansion of Fibre Channel systems.

It shall further be appreciated that RS-232 interface 102 of adapter 100 disposed in system 400 may provide access to both arbitrated loop topologies 400a and 400b. Accordingly, the interface may be used to diagnose hardware units, access storage devices, or otherwise interact with devices on either loop. Moreover, it shall be appreciated that the programable nature of adapter 100 may be further utilized in this architecture. For example, adapter 100 may be programmed to implement various permission groups or otherwise implement network authorization protocols. For example, device 402 may constitute a disk array. Also devices 404 and 405 may constitute PCs. Adapter 100 may allow device 404 to access certain files on device 402 based upon certain security identifiers or other criteria. Similarly, adapter 100 may allow device 405 to access a different set of files on device 402. Moreover, adapter 100 may prohibit device 406 from communicating to any device located on first loop topology 400a. It shall be appreciated that the preceding examples are merely exemplary and any number of authorization protocols may be utilized.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for facilitating communication over a fibre channel (FC) system via a low bandwidth interface connected to a user device, comprising the steps of:
receiving first information from the FC system, wherein the first information is associated with a storage device disposed in the FC system;
processing the first information to identify information intended for the user device;
storing the identified information in a buffer as first stored information; and
communicating the first stored information via the low bandwidth interface to the user device.

2. The method of claim 1 further comprising the steps of receiving second information via the low bandwidth interface from the user device for transmission over the FC system, wherein the second information is associated with a storage device disposed in the FC system;
storing the second information in a buffer as second stored information; and
communicating second stored information via the FC system after an amount of second stored information exceeds a predetermined value.

3. The method of claim 2 further comprising the step of:
utilizing flow control procedures associated with the FC system to prevent a first buffer from being overwritten.

4. The method of claim 3 wherein the low bandwidth interface is an RS-232 interface.

5. The method of claim 2 wherein the user device is a diagnostic PC utilized to diagnosis disk array operations, and wherein the method further comprises the step of:
emulating a disk array.

6. The method of claim 4 wherein the RS-232 interface is connected to a modem.

7. The method of claim 6 wherein remote data access services are facilitated by the modem.

8. The method of claim 7 wherein the remote data services are associated with an Internet Service Provider.

9. A system for facilitating communication over a fibre channel (FC) system via a low bandwidth interface connected to a user device, comprising:
a buffer;
an interface to the FC system;
a low bandwidth interface; and
a microprocessor, wherein the microprocessor is disposed to arbitrate access to the FC system to communicate information received from the low bandwidth interface when an amount of received information exceeds a predetermined value, wherein the microprocessor causes information received from the FC system to be buffered before communication via the low bandwidth interface, and wherein communicated information is associated with a storage device disposed in the FC system.

10. The system of claim 9 wherein the low bandwidth interface is an RS-232 interface.

11. The system of claim 10 wherein the user device is a personal computer and an array controller is disposed in the FC system.

12. The system of claim 11 wherein the array controller is a network controller.

13. The system of claim 12 wherein the array controller implements network drive access protocols.

14. The system of claim 9 wherein the microprocessor operates under an instruction set designed to emulate a disk array system.

15. The system of claim 9 wherein the microprocessor utilizes flow control procedures associated with the FC system to prevent the buffer from being overwritten.

16. The system of claim 10 wherein the FC system comprises a storage device, and wherein the user device is associated with a modem to facilitate remote mirroring of data associated with the storage device.

17. A system for facilitating communication between Fibre Channel arbitrated loop topologies via a low bandwidth interface connected to a user device, comprising:
a buffer;
a first interface to a first Fibre Channel arbitrated loop topology;
a second interface to a second Fibre Channel arbitrated loop topology;
a low bandwidth interface; and
a microprocessor, wherein the microprocessor facilitates communication between the first and second Fibre Channel arbitrated loop topologies, wherein the microprocessor is disposed to arbitrate access to at least one of the first and second Fibre Channel arbitrated loop topologies to communicate information received from the low bandwidth interface, and wherein the microprocessor causes information received from at least one of the first and second Fibre Channel arbitrated loop topologies to be buffered before communication via the low bandwidth interface.

18. The system of claim 17 wherein the microprocessor operates under the control of an instruction set to provide authorization protocols.

19. The system of claim 17 wherein the microprocessor restricts communication with a restricted device resident on said first arbitrated loop topology.

20. The system of claim 20 wherein the restricted device is a storage unit.
